(19) United States
(12) Patent Application Publication
(10) Pub. No.: US 2005/0010512 A1
(43) Pub. Date: Jan. 13, 2005

(54) Method and apparatus for computer-implemented generation and administration of contracts

(76) Inventors: Roger Gutbrod, Sandhausen (DE); Gerhard Hafner, Eppelheim (DE); Hans-Dieter Scheuermann, Birkenau (DE)

Correspondence Address: KENYON & KENYON, 1500 K STREET, N.W., SUITE 700, WASHINGTON, DC, 20005, US

(21) Appl. No.: 10/846,865

(22) Filed: May 17, 2004

Related U.S. Application Data
(63) Continuation of application No. PCT/EP02/12924, filed on Nov. 18, 2002.
(60) Provisional application No. 60/331,470, filed on Nov. 16, 2001.

(51) Int. Cl. G06F 17/60

(52) U.S. Cl. 705/35; 705/40; 705/15

(57) ABSTRACT

Method and apparatus for the computer implemented generation and administration of contracts between a supplier and one or more customers, wherein each contract consists of core data relating to a product which is the subject of the contract and one or more contractual components, the core data being stored in a first memory unit and the contractual components being stored in a second memory unit, and in order to draw up a contract a selection of core data is made and the contract is generated electronically of the selection made by automatically generating and depositing electronic references (links) to the selected core data and contractual components.

### CROSS REFERENCE TO RELATED APPLICATIONS

This application is a continuation of International Application No. PCT/EP02/12924, filed Nov. 18, 2002, which claims the benefit under 35 U.S.C. § 119(e) of U.S. Provisional Application No. 60/331,470, filed Nov. 16, 2001, all of which are hereby incorporated herein by reference.

### BACKGROUND OF THE INVENTION

Currently, banks operate in their application landscapes with a number of product-or savings-specific systems. The running of these is cost intensive and cannot be scaled up. Accordingly, there is a need in the art for a system and method that simplifies running processes and substantial product savings neutrality within the scope of the banking business, for example.

### SUMMARY OF THE INVENTION

The present invention relates to a method and an apparatus for the computer-implemented administration of financial processes and particularly for the generation and administration of contracts, such as contracts connected with the provision of financial services.

According to an embodiment of the invention, contracts between a supplier and one or more customers are generated and administered with computer assistance. The contracts to be generated and administered consist of core data relating to a product which is the subject of the contract and one or more contractual components, the core data being stored in a first memory unit and the contractual components being stored in a second memory unit. In order to draw up a contract a selection of core data is made and a selection of contractual components is made, and the contract is generated electronically on the basis of the selection made by automatically generating and depositing electronic references (links; so-called pointers) to the selected core data and contractual components. Thus, according to the invention, a so-called contractual framework is provided which helps to minimise the amount of data to be administered.

When a contract is concluded between a bank and a partner (customer, other bank) relating to a specific product (account, credit card, etc) this is done on the basis of a pro-forma contract kept on file relating to the existing product with the option of overwriting for individual agreements. Within the scope of the contract framework, there is product generation and administration going beyond the product. The core data of the contract such as the identification number, specific product to which the contract relates, etc., as well as contractual components for central data administration and association are generated during the setting up of the system and duly allocated. The contractual components form the basis for possible agreements which are made up of core data and contractual components by means of the allocation which has been input. This allocation constitutes a product definition, so to speak. When general changes are made to the framework conditions, as for example in the case of statutory amendments, an amendment to this effect is made only at one point and is then centrally incorporated in all existing and/or future contracts by means of the association provided. Thus, a bank can create further contractual components relatively easily and the time spent servicing existing contracts is minimised. Reconstruction is made possible by the time linking of amendments made. Future amendments can also be carried out independently of contractual components. Amendments are pre-recorded for the entire system.

By the use of an identification system which is recognised worldwide (GUID=Global Unified ID) internal identification of a contract with all its components which can be unambiguously linked to external data is carried out, while the external data may also change without losing a link or connection. Coupled with the inputting of several, preferably three holiday calendars, this produces a system which can be connected up worldwide in which domestic and foreign bookings can be made, particularly by means of just one system.

Limits to the processes can be set by the bank itself.

For a release change, any customer-specific enlargement which may be present is retained on the basis of the interfaces defined. For this purpose an expansion is called up during checking.

The basis of the error concept according to the invention is a unified representation of the errors originating from individual contractual components.

According to an embodiment of the invention, first of all a selection of core data and then a selection of the contractual components is made, while on the basis of the core data selected which contain information and rules relating to the product which is the subject of the contract, the admissibility of the choice of individual contractual components is automatically checked. This measure according to the invention makes it possible to control the admissibility of the combination of individual contractual components automatically when drawing up the contract. This does away with the expense of additional checking of a contract once drawn up. In addition, the method according to the invention of including in the core data information and rules relating to products which are the subject of the contract makes it possible to produce a central product configuration.

According to an embodiment of the invention, changes to the core data and/or the contractual components extending throughout the contract are carried out in the central memory unit. This step according to the invention minimises the servicing work as changes to individual components of the contract (e.g. changes imposed by changes in the law) do not have to be carried out in each individual existing contract but can be made centrally. A change in the core data and hence properties of the products to which the contract relates can also be centrally amended in this way with effect for all existing and future contracts. Advantageously, the centrally made amendments to the core data and/or contractual components are associated with time and/or date references which show from when an amendment is to be valid. Thus, impending amendments (such as changes in the law from the next year) can be included beforehand and will automatically be set in train from the later date defined.

According to an embodiment of the invention, changes in the core data and/or contractual components are recorded according to time and stored by means of links. This measure makes it possible to trace back any changes and generate a contract history.

Thus, according to the invention, a so called contractual framework is provided with which it is possible to obtain interplay between the outside world, the contract to be concluded and the product to which the contract relates, by means of so called core data and contractual components. Any desired agreements between the contracting partners can be recorded. Preferably, the invention is used in the field of finance, i.e. the supplier is preferably a financial service provider such as a bank and the products to which the contract relates are financial products such as a giro account, savings account, credit card, cheque card etc. An essential aspect of the invention is that it does not distinguish between different savings products (such as giro, savings, credit etc) but thanks to the central product configuration in the core data allows a flexible structure which also permits mixed forms, something which is not possible with the prior art as it stands.

According to an embodiment of the invention, central functions are provided by the contractual framework for all the contractual components and specialisations (in the core data), such as for example time-dependency, release, proof of amendment, direct input, control of the agreement, spin offs, changes of products, copying of agreements, central field modifications, corrections and locks.

According to an embodiment of the invention the contract is clearly identified by means of an identifier, particularly an identification number. This is preferably an identification which is valid worldwide (GUID, Global Unified ID).

The contract, which in the last analysis consists of a table of links or connections, controls the “communication” with the product and ensures that all the contractual components have the properties defined in the product (i.e. in the core data).

In particular, the contract has the central attributes
Product type
Product inversion
Currency
Status
Holiday calendars.

According to an embodiment of the invention, three holiday calendars can be incorporated, which is advantageous particularly when calculating the value date of a booking. A “booking” day is regarded as a holiday if it is shown as a holiday in one of the calendars. The preferably three holiday calendars are the calendars which are applicable in the territory of the organising unit administered by the contract, the contracting partners and the currency of the contract.

According to an embodiment of the invention the contractual component checks, after generation of the contract, whether the data taken from the product which is the subject of the contract have been changed or not, and initiates the storing of a link from the product to the contractual component in a contract link table which contains the link between the contract and the contractual component, if no amendments have been made, or arranges for the amendment to be stored as a new entry in a contractual component table if an amendment has been made.

The invention clearly also extends to computer programmes with programme coding means which are suitable for carrying out a method according to the invention when the computer programme is run on a computer, and computer-readable data carrying media with computer programmes according to the invention stored thereon and to computer programme products with computer-readable data carrying media of this kind.

Further features and embodiments of the invention will become apparent from the description and the accompanying drawings.

It will be understood that the features mentioned above and those to be described hereinafter may be used not only in the particular combination given but also in other combinations or on their own without departing from the scope of the present invention.

### BRIEF DESCRIPTION OF THE DRAWINGS

The invention is schematically illustrated by means of an embodiment shown in the drawings and is hereinafter described in detail with reference to the drawings.

FIG. 1 is a block diagram of a target application landscape according to the invention.

FIG. 2 also shows, in the form of a block diagram, the components of the account management according to the invention.

FIG. 3 is a block diagram showing the interplay between the components according to the invention within the turnover processing (where DispoOffice denotes Posting Control Office, DispoRules denotes Posting Control Rules, DispoEvents denotes Posting Control Events or Posting Locks and DispoEvent Handler denotes Posting Lock Manager).

FIG. 4 is a block diagram showing the structure of the Posting Lock Office according to the invention.

FIG. 5 is a block diagram showing an overview of the structure of the core application account management.

FIG. 6 is a block diagram showing the embedding of the contract framework according to the invention in a system environment.

FIG. 7 is a block diagram showing the structural makeup of the contract framework according to the invention.

FIG. 8 is a block diagram showing the interplay of the components product, contract and contractual component.

FIG. 9 is a representation of the allocating structures.

FIG. 10 shows a data model according to the invention.

FIG. 11 is a diagrammatic view of a development workbench for developing the business data tools according to the invention.

FIG. 12 illustrates the progress of the dialogue in the business data tool according to the invention.

FIG. 13 illustrates the progress of direct inputting.

FIG. 14 illustrates the structure according to the invention directed to one contractual component.

FIG. 15 shows a sequence according to the invention during the setting up of a contract.

### DETAILED DESCRIPTION

First of all, the technical environment of the invention will be described.

The results of a detailed analysis of the market, in collaboration with international banks and consultancies, are reflected in the current software solutions used by the applicant and further development projects. On the basis of this collaboration in recent years a target application landscape for banks has been developed which is based on the needs of the international finance markets. The individual applications of this software architecture constitute solutions and integral parts of solutions of the so-called E-Business solution MySAP Banking. Essentially, MySAP Banking can be divided into the areas of core banking, SEM for banks and CRM for banks.

Applications are information systems which solve a primary problem of operational economics and which can be implemented per se. They contain the data and functions to solve the primary problem, i.e. they combine activities which are closely related in subject matter. An application communicates through defined interfaces. As a rule an application is a marketable solution. Examples are Product Account Management, Profit Analyser and Risk Analyser.

In the following embodiments applications are divided into core applications and accessory applications:

Core applications are the main applications of the application landscape. Accessory applications are supplementary applications which widen the scope of function of core applications (including more than one). They perform special tasks (examples include limit determination and scoring models) and have their own investment cycle independent of the core applications. This ensures greater flexibility in adaptation to changing political targets in business.

The application landscape of the e-business solution mySAP banking describes the essential applications needed to operate the banking business. The applications are connected according to operational economic logic.

“Technical Architecture” describes the linkage between applications by a middleware. “Application Architecture” describes the business management content of individual applications and the logical interplay of individual parts of an application. These parts are known as components.

The applications of SAP are constructed according to a shell model: In the nucleus is the solution for the international use of the software and as a supplement to this country-specific solutions are provided. Individual customer supplements may be added on in another shell based on BTEs (Business Transaction Events) or BADIs (business Add-Ins) or the use of BAPIs (Business Application Programming Interfaces).

Financial Institutions and Banks make the following demands of applications:
Customer-centred and distribution method—neutral support for the sales/service processes.
Fast reaction to system demands for the development of new products.
Possibility of integrating new business processes.
Product division—neutral development of contracts and unified stock control.
Integration and consistency of internal and external billing.

The following demands are made of the application landscape:
Flexible modernisation of the application landscape for years to come (depending on the investment cycle of the applications).
Fast reaction to changing business models (e.g. Outsourcing, Insourcing).
Client-specific expansion possibilities without modifying the standard solution.
Support for different migration scenarios.
Flexible integration into existing application landscapes in banks.
Reduction in the interface complexity by integrated processing within the SAP application landscape.

The result of this, for the application landscape sought:
The individual applications are interchangeable and expandable. In particular, individual applications should not be too extensive. In an integrated system landscape of the SAP individual applications must be able to be deactivated and foreign applications must be able to be integrated.
The bank decides by the choice of applications on the desired extent of standard functions.
Each application must be capable of being expanded so that integration in client-specific application landscapes can be developed by the SAP, by certified partners or by the clients themselves.

Clear Competence of Applications

If we look at central bank processes, various tasks and information requirements can be derived. These different requirements conflict with one another to some extent and form an obstacle to the optimum construction of individual solutions. Thus, a client-centred processing is the demand for distribution and service organisation in a solution. The cost-reducing developing of contracts and accounts, on the other hand, is contract oriented. Internal and external billing in turn aligns the processes with legal and organisational conditions.

Applications communicate through public interfaces. No direct access is allowed to applications. This ensures that data exchange can take place transparently between applications. Within an application a consistent database is guaranteed. Unexpected risks caused by unknown linkages and access can be minimised. This communication structure allows direct data exchange between applications through public interfaces or indirect data exchange through public interfaces and business management middleware. For example, the Posting Control Office can communicate with the account management through public interfaces; however, the data exchange may also take place via middleware with its own business intelligence.

Middleware is a central element for implementing an application landscape. Middleware can perform two functions:
Technical communication (services)
Business management control (Business Rules)

There are various solutions on the market for technical communications, this allows the exchange of information between different data banks in different formats.

Business management control of business cases demands a regulating mechanism. This is defined as the Business Rule. Process knowledge which covers the application is necessary in order to implement the Business Rules.

Elements of the Business Rules are process objects which initiate the call up of business objects in the individual applications. Examples include “contract arrangement”: this refers for example to the business objects of business partner, contract and card product. The imaging of front ends and back ends using Middleware is a widespread practice. However, it is also necessary to back up back end processes between applications, something which is not well established. Therefore, for reinvestments in these fields it is essential to have a clear concept of process control.

This construction also allows stepwise migration with successive opening up of new applications.

For SAP the interplay of applications and Middleware has a strategic significance and is currently being actively promoted. Within the scope of the analysis of technical feasibility the question of performance plays an important role.

The structure of the target application landscape shows “key functional areas” with which the bank management solution fields can be imaged. Within one such area there may be a number of applications. The area which contains applications that banks require in order to carry out their secondary processes, such as for example personal finance, systems accounting, material management, etc, is not shown.

The basis for this structure is the goal of defining areas of application on a high level which serves a specific main purpose. In this way it is possible to derive applications and define clear competencies. Redundant applications and functions can be avoided. The landscape of the following main functions is well known:
Applications for client-centred performance of sales and service processes.
Applications for carrying out and monitoring trade processes.
Applications for contract-centred high performance working.
Applications for legally and organisationally induced data calculation and preparation for bank control.
Applications for the central preparation of data which supports the other areas to an optimum degree without being redundant.

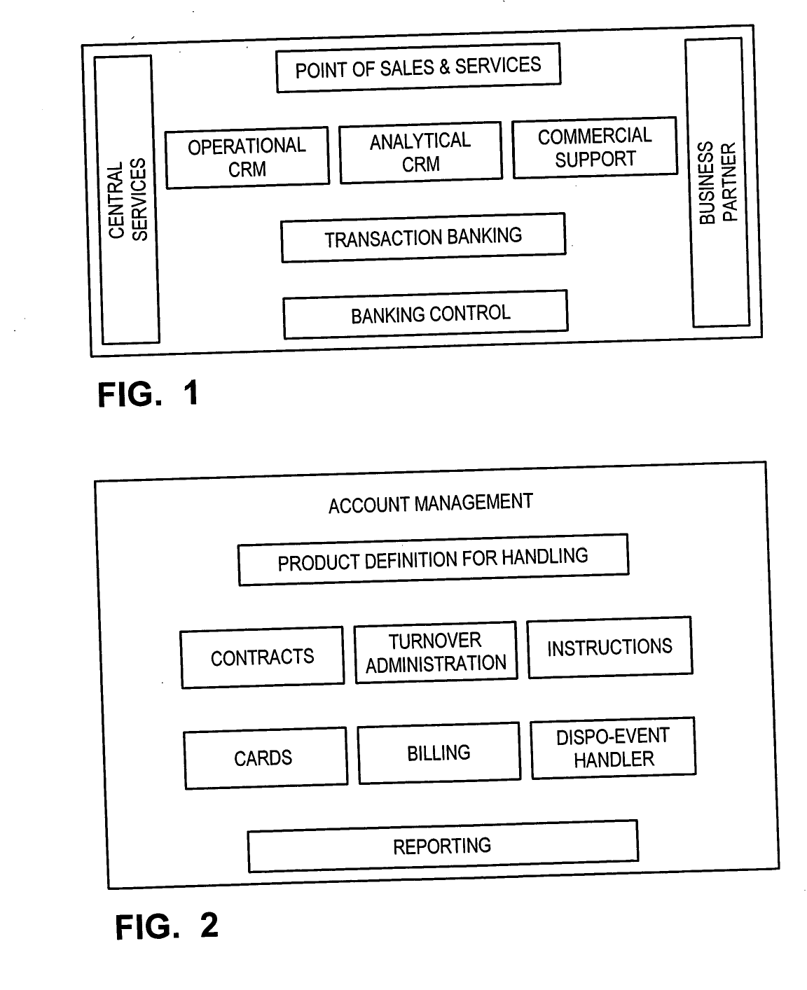

FIG. 1 is a diagrammatic view of a block diagram showing a target application landscape for account management according to the invention.

In the top level of the block diagram in FIG. 1, in the box “Point of Sales and Services” is the customer interface to the sales and service department of the bank, such as the call centre in telephone banking or a subsidiary branch.

In the second level of the block diagram under “CRM” are stored data relating to the client, operational data being data regarding existing customers, analytical data being data on the acquisition of new customers.

Finally, in the third level of the block diagram, under transaction banking, are shown contracts with clients. These contracts relate to accounts, borrowing, securities, payment transactions, deposits, etc.

In the bottom fourth level is the bank control.

Every bank communicates with the markets and requires interfaces for this purpose. As a rule, value-added business and business transactions are generated from this interface. It is of central importance for a bank as it also represents its image. Obviously, these interfaces are numerous. The following may be mentioned as essential interfaces:
Personalised two way communication:
Branches, call centres, processing offices and dealing rooms. At these interfaces documents and other rule confirmation of the results of communication are necessary. This form of communication is generally very staff and cost intensive.
Personalised one way communication:
SB-terminals, internet, telephone. Here, a party takes action by inputting data and receives a system generated result. In this case the bank is represented not by its employees but by the system reaction.
System operated two way communication:
electronic dealing systems, clearing systems, payment handling systems, market data input, data exchange with information bureaux, notifications to supervisory authorities. Here, the bank employees only take manual action in the event of a fault.

Whereas in the handling of payments system-operated data exchange has been continuously worked on in recent decades, in terms of customer care there was an innovative breakthrough only with the advent of direct banking. This breakthrough was accelerated by the internet and, after retail business (online banking) now encompasses wholesale business (e.g. accreditive processing) and dealing (e.g. increases in issues; increase in electronic trading places).

These new interfaces have to be integrated into the existing IT landscape of a bank. Therefore, it makes sense to uncouple the distribution channels and encapsulate them so that it is possible to adapt to the rapidly changing trends. This rapid reaction time can only be achieved if as little business management logic as possible is contained in the front ends and is located in an application area which is “distribution route-neutral”.

The front ends are supposed to encompass all the client-initiated business. Only in this way is it possible to make use of synergies and process optimisation of a modern software solution. Moreover, the organisational decision to leave certain business transactions to be done directly by the customer can be put into practice more easily (e.g. the now common use of ATM terminals or internet or mobile phones for giving payment instructions, ordering foreign currency, etc).

Between the forms of communication there is a network. Thus, for example, telephone users can be connected to a call centre by the click of a button if they experience problems in inputting data. Against this background it is all the more important to maintain data through all distribution pathways at a uniform status so that all employees are informed as to the activities and history of the client.

Customer Relationship Management (CRM) encompasses the whole range of analysis, activities and documentation in the field of client contact. Thus, not only are sales processes and the associated marketing relevant but also services throughout the period of the contract. CRM is more than a databank with marketing data for SAP. It includes operative processes with corresponding data management. Many functions are present in redundant form for each channel in market solutions of this kind. The goal of SAP within the scope of CRM applications is to achieve immediate availability of business and distribution functions independently of the distribution channel.

In operational CRM the following processes can be defined:
Distribution processes (sales processes) are focused on the acquisition of new business, on the one hand from the client base and on the other by attracting new customers. Depending on the business field (retail/wholesale), the product (payment transactions/active or passive business or business on commission) or customer group this process has different degrees of complexity, risk and yield.
Service processes include customer care during the lifecycle of the contract. The main points include: the desire to block cards, changes of address, complaints.

For mapping the processes described above the following client-centred solutions which are distribution route-neutral are needed in this range of applications:

Contract management supports the drawing up of the request and offer and the conclusion of the contract including correspondence and electronic files. Contract management shows the contractual agreements between the bank and client, in customer-centred manner. The contracts may have any desired degree of complexity. For example a credit agreement secured by life insurance and security in the form of a guarantee may be mentioned. If the contract data are called up, they contain a selection of information relevant to processing supplemented by distribution and service-oriented data. These contracts may be processed by means of a number of applications, i.e. the relationships between individual contracts or partial contracts are documented throughout their entire life. Customer-centred sales and service processes are “anchored” in the contracts of the contract management.

Important processes:
Concluding and documenting the contractual and pre-contractual customer agreements.
Monitoring the content and dates of contractual and pre-contractual terms and events (e.g. conditions for payment; lack of legitimation; extension deadlines).

In product management market related configuration of products takes place. This process is carried out in accordance with the processing area of a bank. The preparation of products in this field of application is concentrated on the market presentation of these products, i.e. on the varying forms which a customer can choose. The product must support mass business in the retail business and guarantee a unified product portfolio and hence contractual portfolio. The degrees of freedom of individual products are generally limited (e.g. as a rule the only variable parameters of a savings bonds are the nominal amount and its term). By contrast with the retail business the wholesale business has high degrees of freedom within the product as the contractual agreements must allow for highly individual forms.

Important services:
Configuration of the product parameters
Product calculation

Activity and contact management makes it possible to detect, monitor and control activities with the customer. Moreover, all contacts with the customer are documented and can be evaluated according to various features. The bank has a “virtual” customer representative who is available through all the distribution channels. For example, a complaint made through the call centre is also visible to the employees at the branch. This ensures a uniform status of information for all the employees who come into contact with the customer. The customer activities on the internet are also to be integrated into the contact management.

The application area “Analytical CRM” includes the processes of analysis for using business and customer potential and converting them into operational use (e.g. marketing measures).

Analysis processes form an essential aspect of an efficient customer relationship management. These include processes such as, for example, cost information for controlling service, marketing and sales actions, customer-specific characteristics for determining further customer potential, information on competitors' products, etc. The primary functions of analytical CRM are:
Customer segmenting and profiling
Campaign Management
Database Marketing

Corresponding solutions support the bank in planning and carrying out marketing measures, begun in the segmenting and profiling of customer bases up to the planning, carrying out and monitoring of marketing campaigns.

CRM is of strategic importance according to the invention for offering total solution competence.

Applications for supporting trading activities are characterised by high product specialisation. Special know how and short investment cycles are the marks of these solutions. To some extent the existing systems still imitate the back office processes. A clear cut makes it possible to process handling and billing processes in cost-decreasing manner. Trading systems often have rudimentary risk monitoring. Banks are increasingly being required to provide the instruments of control of the overall bank control directly in value added manner in the trade area.

Important processes in this area are:
Product configuration for trading
Contract management for trading
Limit management for trading (exposure management).

According to the invention it is not a trading system that is provided but rather the trade activities are monitored.

In the field of transaction banking the starting position is as follows: globalisation of the banking market expresses among other things the intention of market participants to have efficient operating magnitudes. In order to make full use of the effects of scaling and specialisation in recent years a partly internal and partly overarching separation of distribution and transaction banks has developed. Outsourcing solutions are one example of how the transaction bank has succeeded as a business model in its own right. However, while maintaining the running within their own businesses attempts are made to optimise the running of customer business by automation and centralisation.

Currently, banks operate in their application landscapes with a number of product-or savings-specific systems. The running of these is cost intensive and cannot be scaled up. Simplifying running processes and substantial product savings neutrality within the scope of the banking business are major requirements in this field. The configuration of handling processes is supposed to be accelerated and made more flexible by product configuration. The possibility of expanding the software is of crucial importance in this field of business particularly taking account the long investment cycle of 15-20 years.

For the SAP this field of application provides a major strategic contribution to optimising the process in the international banking world. The field of transaction banking has the essential components of payment transactions, account management (handling and stock control), securities settlement and deposit administration (handling and stock control).

Account management has the task of running the legal position in the matter of cash flow, i.e. it provides information as to the requirements and obligations of the bank to third parties. The stock control of account management is the source of bank statements and notifications of balance. The balances and turnover entries are clear of currency, i.e. unconverted. The status is the basis for the external billing, i.e. the contractual and turnover data held here from the database for drawing up the balance.

In account management there is also the handling of (partial) contracts. Partial contracts because a customer contract can be divided up into a number of handling applications owing to its complexity. For example, in operational CRM, a product may consist of a “salary account with credit card and travel insurance”. Whereas the salary account is managed in account management, the handling of the card is carried out by a provider and the travel insurance by a partner. The handling functionality means that automated extensions or contractual billings are carried out. This means for the operational CRM that it must obtain the up to date state of the account from the management.

In account management only legally valid contracts are managed, i.e. simulation business, offers and requests are outside, in operational CRM.

Payment transaction systems are conventionally country-specific solutions. The payment transaction system takes on the formal checking and if necessary the consolidation and distribution of turnover within the routes and formats used by the bank (internal and external routing).

Payment transaction systems conventionally work by the so called batch method. As a supplement, payment instructions must also be given in dialogue form to initiate immediate real time accounting in account management (additional application in payment transactions). Between payment transaction systems and account management a high performance communication must be provided.

Fundamentally, within the scope of the present invention, the management and execution of long term instructions is an additional application in payment transactions (payment instructions and long standing instructions fall within account management). However, it is also possible to carry them out as an additional component within account management (e.g. payment transfer within account management).

The field of transaction banking contains, in addition to the solutions described above for the money side, solutions for security business and derived financial transactions. Thus, it can be assumed that as a rule there are a number of stock control systems in this field. In the management of securities (securities settlement “management of deposits”) there is the peculiarity that within the scope of the customer business this is a stock control which is not on the balance sheet.

The business partner solution is a central application for storing and managing all customer information. This solution is very closely linked to the solutions for operational and analytical CRM. Because of the process linking the business partner is serviced within the scope of these processes. The business partner data constitute an important immaterial asset for every bank the value of which is determined by the quality of the data.

The business partner application combines the customer data of a bank in a manner which transcends the application. The most important data are:
Name and address of the business partner
Additional data depending on the type of business partner (e.g. date of birth; legal status) for all fields of application (e.g. branch key for marketing selection or communications)
Relationships (e.g. borrower unit; concern structures)
Roles
Legitimation data
Creditworthiness data/data from credit reference agencies/scoring results/marketing cluster
Data of budgetary account or balance sheet analysis
Total debts

Links between business partners may be connected with one another in many ways. Functions are provided for forming borrower and risk units.

Customers go to a bank in defined roles (e.g. account holders, borrowers, guarantors). For this reason the business partner application includes the role of a customer as an important component.

The application range “central services” contains solutions which support the banking business of the other areas.
Security management
Output and input management/correspondence
Market data, data of origin of securities, information services
Administrative services: authorisations, organisational units

The administration of securities is of particular importance as a result of the Basle Decisions on risk exposure. By differential allocation of securities a bank can optimise its own capital position and thus reduce its credit cost. Moreover, knowledge of securities and their value is one way of acquiring new business. Recording securities is generally done during the initiation and conclusion of a contract and is initiated from the operational CRM. The clearing of securities is carried out in the course of winding up a contract.

The management of securities includes on the one hand securities which the bank receives and on the other hand securities which the bank itself provides. This second aspect is not currently available on the market in virtually any solution. However, activities of a bank in the derivative field also require documentation and control of securities which they themselves set up.

Management of securities is an important component of the overall solution.

The application of output management/outgoing correspondence constitutes a solution for optimum communication with the customer. Various media are used such as the postal services, fax or e-mail. There may be some dependencies between the media. Statutory notification periods must also be observed (e.g. written notice of the closing of an account).

In addition to the choice of output media a high functionality is needed for controlling and preparing paper correspondence. The key words here are central printing; forms and rationalised postage.

The invention assists the correspondence-oriented data selection and preparation. Further processing in a printing and despatch line is carried out by special suppliers.

The function “electronic file” belongs to input management/incoming correspondence, as does the general linking of documents to the objects of contract, business partner, etc. Input management has become a central service in operational CRM.

This relates to solutions which provide information on a number of applications within a bank.

The services referred to as “administrative services” serve to organise the running of the banking business.

The existing system landscapes have grown up historically in most banks. The operational systems play a central role and deliver downstream systems, often with pre-calculated results. These frequently produce different results and a complicated process of transmission and adaptation. It is no longer possible to make decision within a short space of time. The control of a bank is therefore required to have a single source for the database and consistency of methods through all the evaluation processes. In order to achieve the goal of matching the data and methods, the systems of a bank must be organised differently from hitherto. In particular, a clear distinction must be drawn between the operating systems and the applications of the overall bank control. This freeze the operating systems from the downstream processes of the overall bank control and at the same time centralises the processes. The data required by the operating systems are made available at a data interface.

The bank control relates not only to individual institutions but to entire concerns. Precisely for control throughout the concern, unity and transparency of methods and their presentation are of great benefit.

The following fields are integrated in an overall bank control according to the invention:
Balancing of accounts
Profitability/controlling
Active/passive controlling
Risk controlling
   Market risk/internal models
   Credit/loss of address risk
   Contractor risk
   Country risk
Communications
Limit management (analytical)

Transaction banking has the following central tasks:
Controlling the trade in money and securities
Handling the contractual position
Turnover management and running of the legal position in terms of money and securities

The scope of the solution of transaction banking will be described hereinafter.

In order to embed the functionality of transaction banking in the overall context of the application landscape we will first discuss the following aspects:
Processing options
Data management
Product configuration and financial conditions

Product Options

As an application in its own right transaction banking needs to be able to be processed directly. The reasons for this may be:
Disposition and limit management on the quality control of the position.
Dealing with complaints, such as correcting fees.
Stock control processes, such as for example the processing and agreeing of CpD accounts.
Making corrections on the basis of incorrect or inadequate data input (e.g. value corrections, accounting corrections)

Traditionally, account management is referred to as an add-on to customer care. The invention is designed so that implementation of the account manager is possible. This role comprises the following two fields of work:

On the one hand, they are activities which act directly outwards to the customer (e.g. lowering of limits) and on the other hand activities which affect only the portfolio “without customer contact” (e.g. CpD processing, data correction).

Primarily, distinctions are drawn between two types of processing layers in transaction banking:
Basic Maintenance Interface (BMI)
Handling Office (Account Management Office/AMO)

The Basic Maintenance Interface is an interface for processing individual functions.

This interface allows manual intervention into otherwise largely automated transactions. All functions from this area therefore have an interface. A clearing process guarantees properly revised processing. A clearing tool which is tied into the individual applications in the system is suitable for this.

This interface is made available as standard and the correcting profiles for these work spaces can be defined by the user as roles, so that each user is provided with a menu which precisely satisfies his requirements as to the system.

These interfaces do not take account of any customer-organisational processes or improved running.

The Handling Office (Account Management Office/AMO) guarantees process controlled, i.e. workflow-aided processing of business incidents. Within the office there are different role-based functions. The control is assisted by adjustments to the SAP workflow in accordance with individual customers and associated clearing processes (4 to 8-eye principles). Compared with the basic maintenance interfaces these offices have their own data management (e.g. disposition orders). Access to functions and data for processing the business incidents, extending beyond the application, is crucial to tying in the office. Moreover, the results of the office activities should be transmitted to the central contact management so as to allow a fully client-centred view right through the bank.

In management today there are frequently processes which do not belong in this category (e.g. opening up an agreement by post).

Market studies have additionally shown that the aim of banks is to slim numerous back office processes by 70-80% purely by shifting them onto the customer, as is already done by internet banking (e.g. opening up an agreement). Management is only at its most efficient when the customer of the bank can himself initiate business such as for example blocking a card or can arrange for payment instructions.

Guiding Data Management

In every application landscape there can only be one “master” for the data to which other applications apply directly or obtain periodic updates.

The master for the partial agreements which are to be handled is in the account management, i.e. the appropriate contractual data and conditions are deposited there.

The same is true of turnovers and balances. Therefore, on this basis, data is prepared for the bank statements and for a data warehouse.

The extent to which applications have to hold redundant data is determined largely by the performance requirements and depends on the individual customer's situation.

Product Configuration and Financial Conditions

Product Configuration

As shown in the target application landscape, product configuration is a central theme in a modern solution looking towards the future. Product configuration comprises three essential aspects:
Product configuration in the operational CRM. Here, product configuration is oriented according to the requirements of marketing and sales.
The formation of the handling product with all the control parameters relevant to this handling within transaction banking/account management. A product presented to the market can be divided into a number of partial products for handling.
The configuration of products for bank control. These products generally have a different granularity from the handling products. Data management is also aligned with the needs of evaluation and not the requirements of handling.

In the three main processes of banking the product is differently emphasised, with the exception of one area: “the financial condition of the product”. For this reason the financial conditions are additionally shown.

Finally, the product configuration extends over all three fields of application. Overall coordination between the fields of application is essential within the framework of the implementation of a new product. The products are promoted in each area per se:

In transaction banking the product promotion takes place through customising. Authorisation and clearing are ensured by means of the transporting methods of SAP.

The connection between operational CRM and transaction banking is obtained by making a specific contract with a client through a public interface (BAPI). The following are given at the interface:
the customer
the product ID
and the individual terms of the contract.

The product ID provides the connection with the (partial) handling product.

Financial Conditions

The financial conditions are the basis for calculating interest and fees. They are therefore particularly important and must be available in every field of application. Access is critical to performance within the scope of stock control. In order to guarantee that the conditions remain consistent beyond the limits of individual fields of application, SAP makes the financial conditions of account management available to all other applications through BAPIs.

FIG. 2 illustrated by means of a block diagram the components of account management. Account management has a product savings-neutral structure. First of all payment transaction products and services as well as passive and active products of retail banking are in the focus of development.

The contractual component is designed as a framework. It is therefore possible to use it as a central service for all applications of the target application landscape.

It is conceivable that the contract and its framework may in future be used as the central service for all applications of the target application landscape.

The contract manages all the basic data relevant to handling in the account management by means of contractual components. Contracts use products as their basic ingredient. The contract is directed to the highest possible performance in running mass business.

Freed-up contracts are generally passed on to the contract management from the previous systems through an interface BAPI. However, during the life of the contract it can be expected that there will be direct access to the contract from transaction banking and data will be changed. Particular contracts such as, for example, contracts for CpD accounts are placed directly in account management. The contract recognises the freed-up and non-freed up state.

For all contractual data there can only be one “master” in an application landscape. This “master” is in account management for the handling data. Moreover, contracts are substantially managed automatically. That means that in this case the current state of the contract is known (e.g. after extensions). The contractual data are made available at interfaces.

As an explanation we should point out that there are of course contractual data which are managed in other applications and run as “master” (e.g. security identifications, authorisation of access). The central anchor for combining all the data is in the operational CRM.

Important processes in account management are:

Investing, altering, extending, terminating, cancelling and dissolving contracts. These also affect the corresponding accounts. Two features of contracts are supported:
Account agreements
Card agreements (see below)

It will be understood that it is also possible to support other parties to the agreements.

Turnover Administration

The essential added value of account management lies in producing and handling movement data. The solution must be high performing and incur little cost. Other requirements of the solution are real time processing and availability 7×24 hours.

The turnover administration logs the individual turnovers in real time and controls a flexible updating of the account. The movements are monitored on the account. Individual transactions are payment entries (half sentences) which are based on the one hand on payment instructions and on the other hand on internal accounting (e.g. payment of interest). Additionally it is possible to calculate and process cash flows. Account management has an interface for receiving payment entries (BAPI).

Turnover administration does not recognise any open posting administration with corresponding balancing of individual posts. It is possible to monitor payments on the basis of the balance, which, for example, controls the input of funds in the course of a fixed money system or the payment of instalments in the case of credits.

Incoming payment entries are checked within the material arrangement for barriers and limits. A regulating mechanism (posting control rules) flexibly controls the reaction of the system by means of given parameters. Thus, for example, it is possible to determine, specifically for customer groups, whether a turnover is to be disposed of later or transmitted directly.

System reactions are:

Accounting, letter procurement, subsequent processing, return, refusal, CpD accounting.

The individual turnover is also the basis for the ledger handover. The data are also used for producing bank statements. The updating of transactions is clear of any currency and non-evaluated.

Orders or instructions describe the actions which the account management is to perform immediately or in the future. This means that instructions can be monitored in a watching file. These instructions may alter one or more objects.

Account management processes instructions. Examples are “dissolving contracts” and “setting limits”. These instructions are initiated from outside through interfaces or internally by the application itself (e.g. watching deadlines for card renewals).

Other additional functions envisaged are central applications such as long term administration of instructions and payment orders (cf the preceding remarks).

The card solution uses these same components of product configurator, contract and financial conditions as the account management. Thus, the administration of cards is a specialisation of the general contract. It is necessary to integrate card administration into account management as there are close links between cards and accounts (e.g. EC card, debit card). In particular, SAP want to keep the option of handling credit card accounts in the medium term at the turnover end.

Card administration must constitute a solution which can optionally be used by the customer, i.e. card administration must be capable of being switched off within the account management. Moreover, the card administration should be capable of being dismantled in the medium term to such an extent that it can be used as an individual solution if there is a corresponding demand in the market. According to present experience, there is a need for an account management system including and excluding card administration. Hitherto there have not been any enquiries for card administration on its own.

Account management has a central administration for periodic work (e.g. processing at the end of the day). The bank gets maximum flexibility when planning the jobs. Covered under periodic working are the functions which have to be carried out repeatedly at a certain date. These include the closing down work of cash concentration, closure of accounts, interest compensation, bank statements, processing instructions, daily closure including updating the books and reporting. Before the closing work is carried out a cut off point is provided in the booking. After that, all bookings carry the next days date.

External systems for job control can also be tied in.

The Posting Lock Manager (lock administration) is responsible for temporary accounting locks, i.e. he imposes barriers which are initiated by business events (posting lock events) and releases these barriers after the event in question has passed. Barriers which are defined a priori on the product are not included in this component.

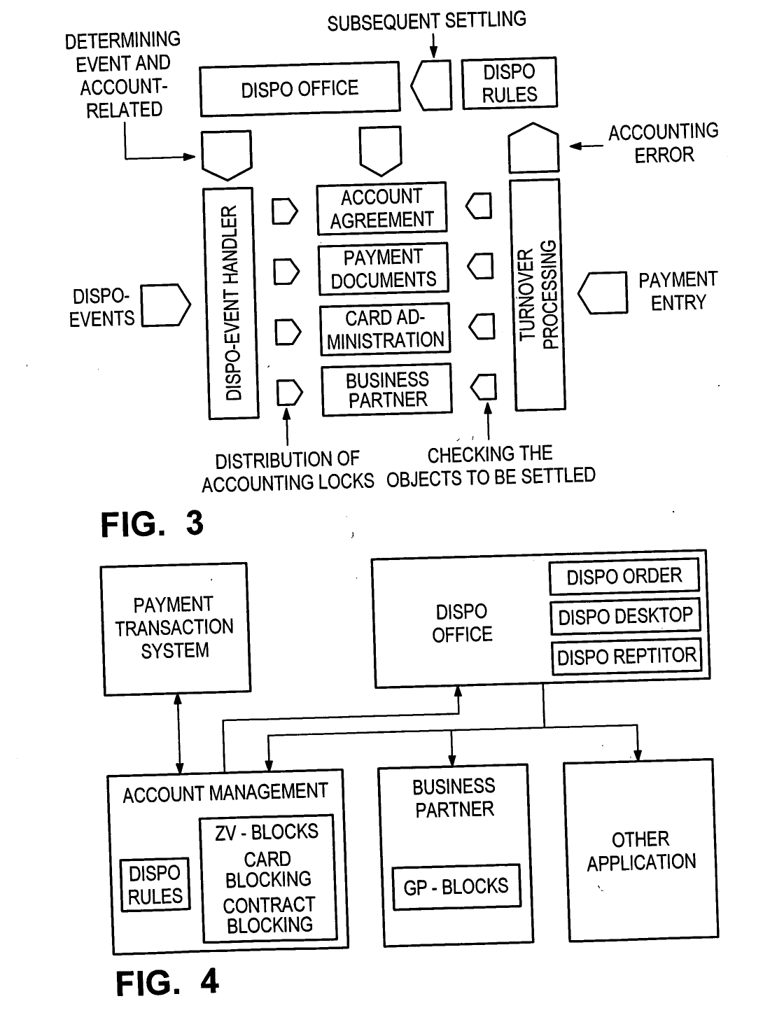

FIG. 3 shows a block diagram to illustrate the interplay within the turnover processing with the participation of the so called Posting Lock Manager and FIG. 4 is a block diagram illustrating the structure of the so called posting control office.

The Posting Lock Manager accepts posting control locks from various input channels (back office, call centre or switching systems and credit reference agencies) and determines the reaction of the system, according to the rules. The solution runs largely without any manual intervention in operation (receipt and processing of events). In account management, possible manifestations of blocking processes are contract blocking (the contract as a whole and the blocking of partial functions), the blocking of cards in the portfolio as well as cheques and other printed payment means. At the business partner the central business partner lock can be imposed, extending across all the accounts held by the customer.

If for example a business partner notifies an arrangement, the Posting Lock Manager distributes suitable barriers. Thus, this rule may for example prevent overdrawing and debits on all accounts and may block all the cards for the business partner in question. This regulating mechanism can be extended in customer-specific manner.

As a result of the primary function of account management, of managing the legal position, flexible reporting is available. This includes numerous lists such as for example lists of overdrawings, balances and transactions. It is also possible to draw up lists for blocked accounts and cheques and reconciled balance lists for comparing the payment transaction balances.

The definition of other reports is flexibly possible.

Accessory applications to account management from the point of view of the application landscape are:
Posting Control Office
Dynamic limit setting
Warnings/interest on overdrafts

As mentioned hereinbefore, accessory applications add to or support the function or task of one or more core applications.

The Posting Control Office is an additional application to account management which serves to provide payment entries in which a lock or unauthorised overdrawing has been detected in the accounting.

Payment entries which come up against booking obstacles (locks) in account management and accounts in which there is an unauthorised overdraft are disposed of according to a regulating mechanism (posting control rules). This regulating mechanism which can be adjusted in client specific manner is administered in account management. If desired, information on payment entries which are not explicitly rejected in response to the posting control rules are diverted to the posting control office by means of a disposal order (Posting Control Order), where they are further processed (settled) either mechanically or manually. Mechanical settlement (repetitor) comprises automatic resubmission of payment entries for accounting to account management. Payment entries for which there are only temporary booking obstacles (e.g. limit problems) can be settled without any manual intervention by means of the repetitor.

The duration and frequency of resubmission and the final reaction (e.g. rejection) in the case of unresolved or fresh obstacles to booking can be adjusted.

The manual processing of payment entries which are to be settled is carried out at the posting control desktop. In this partial solution the role-based set up and usability are of central importance. The disposing manager is assisted in his decision by access to data relevant to the decision, either to finally deal with the payment entry (book or reject actions etc) or pass them on for mechanical settlement.

Dynamic limit setting is a solution which is required particularly in automated mass business. This is an accessory application to account management which allows the individual bank to set automatic limits for the customer on the basis of defined rules and input parameters.

Dynamic limit setting is programmed by the customer or in customer projects to suit individual requirements. The limit setting communicates with the stock control, the business partner and the operational CRM.

This accessory application is responsible for out-of-court warning processes.

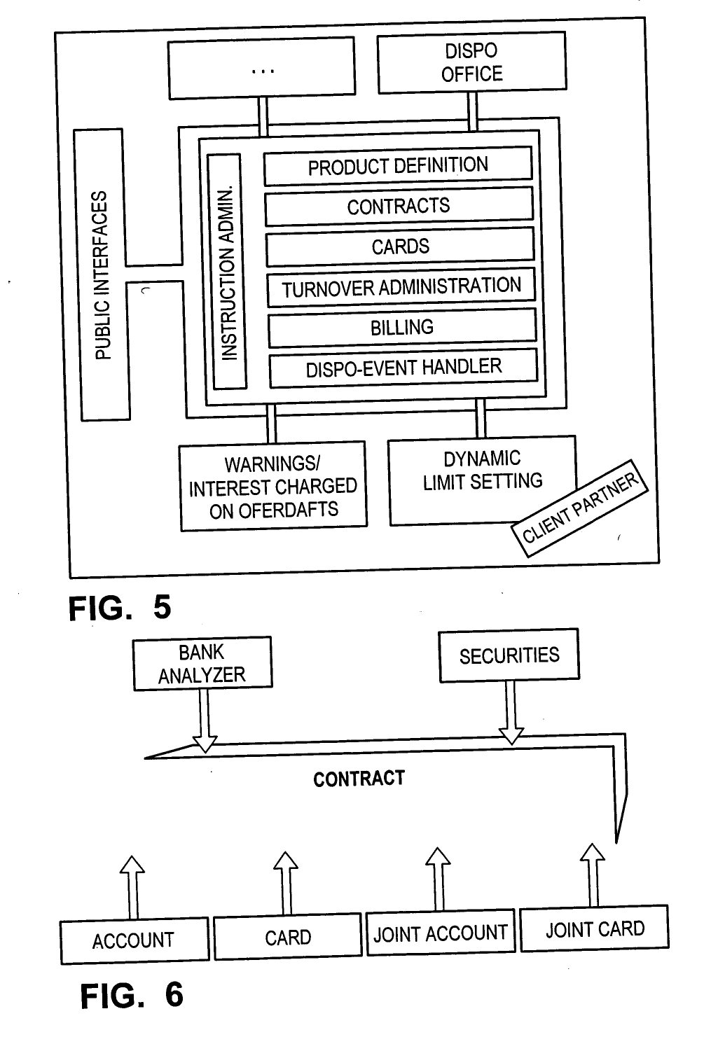

FIG. 5 is a block diagram providing a summarising overview of the structure of the core application account management.

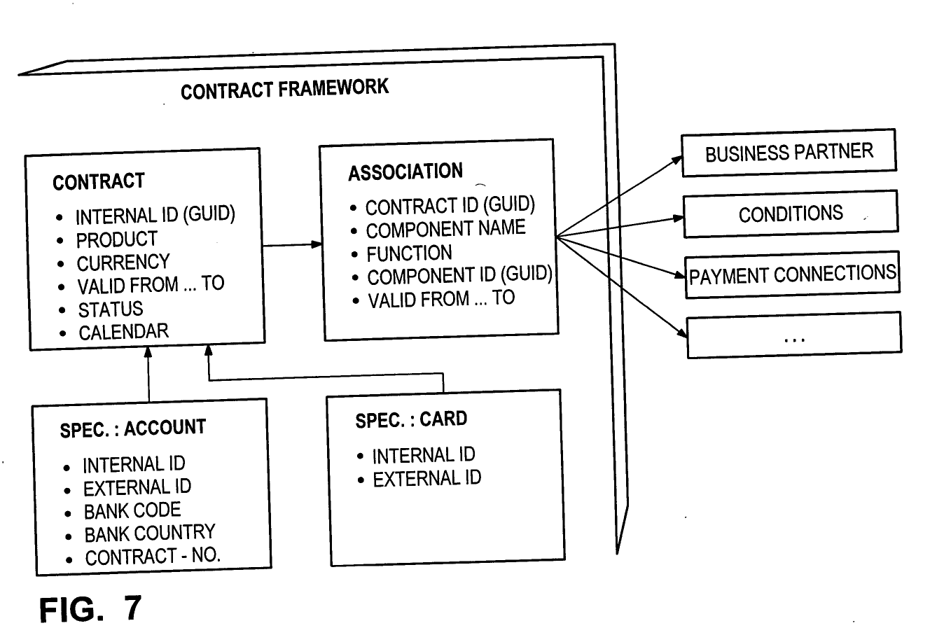

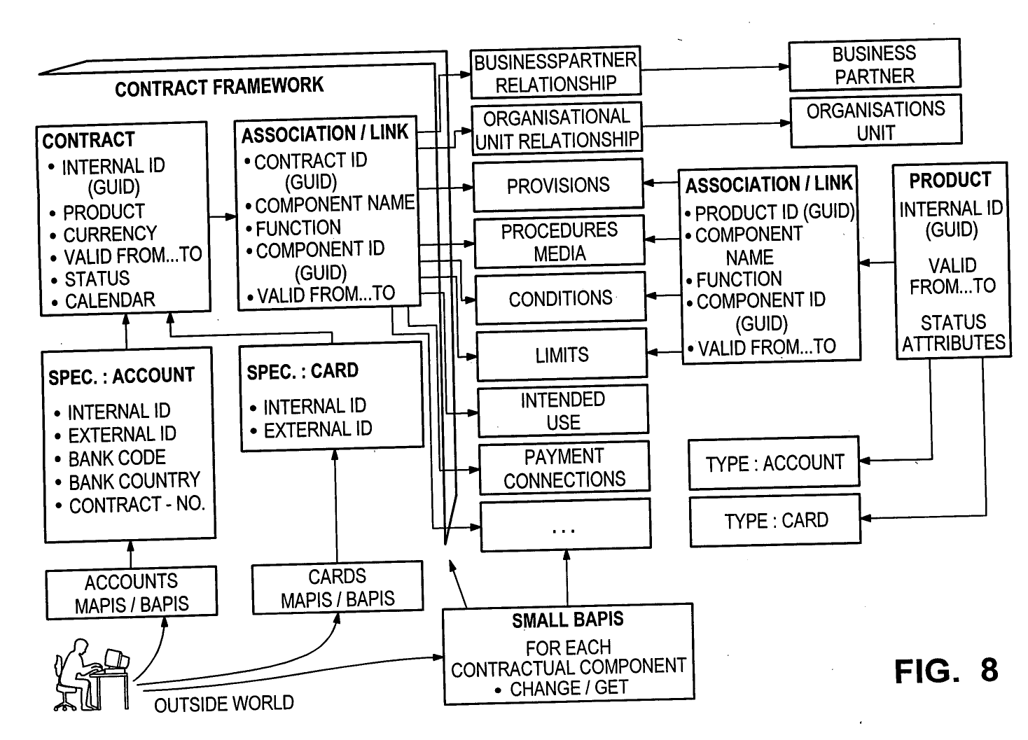

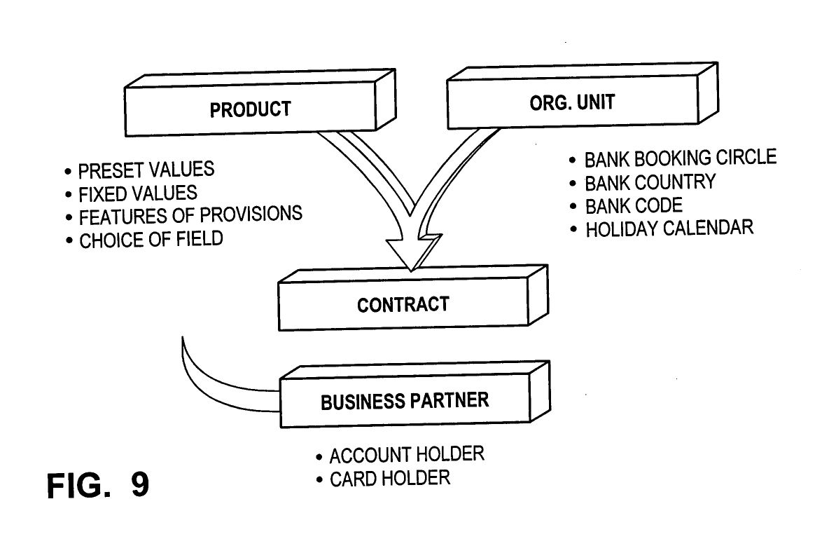

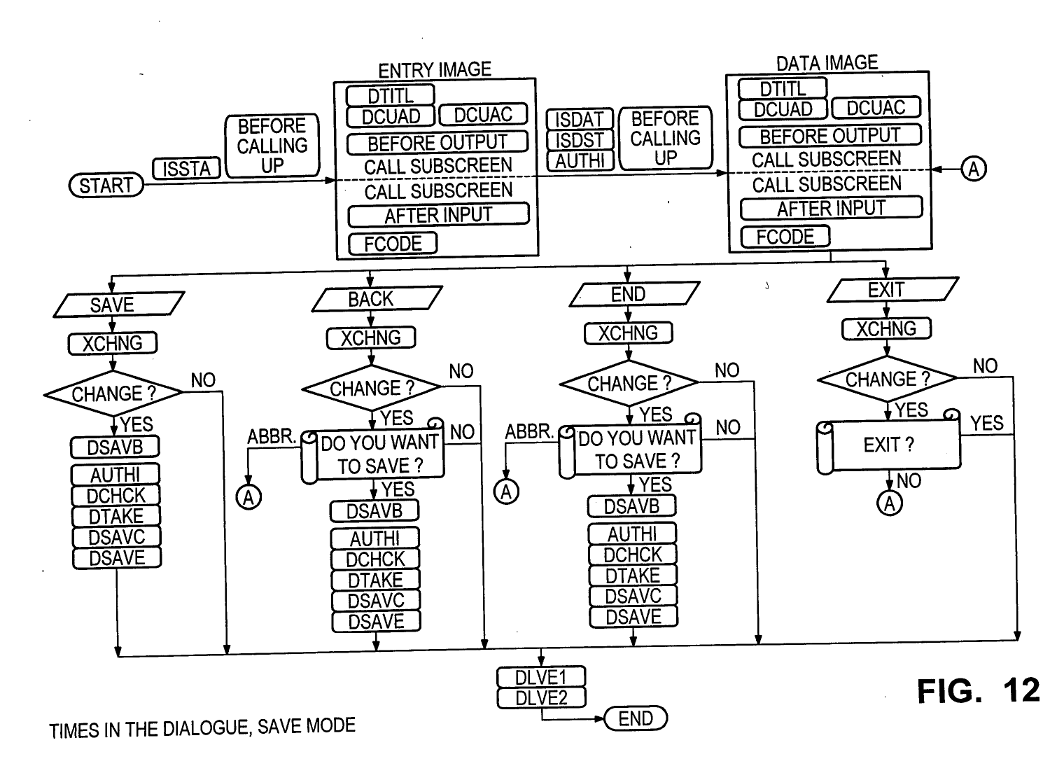

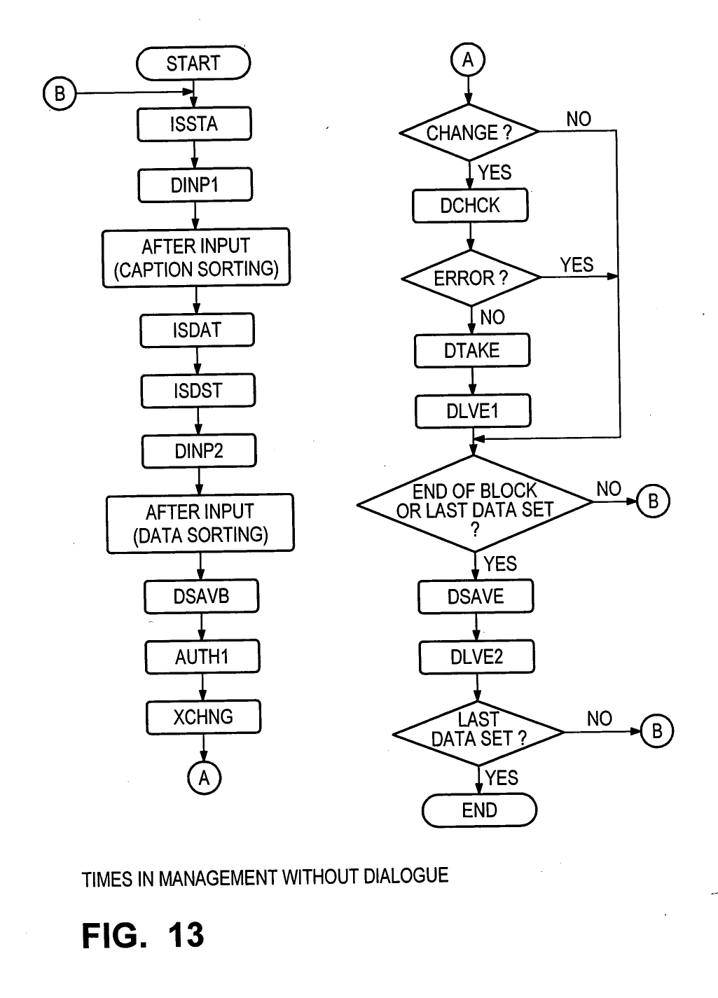

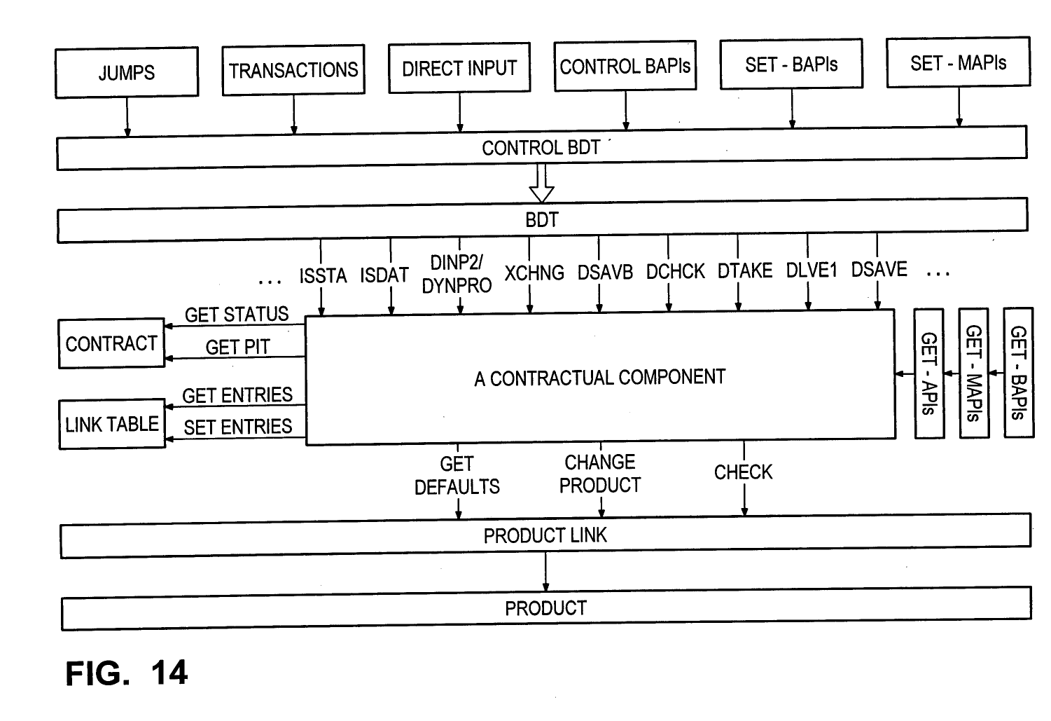

The invention will now be described in more detail with reference to FIGS. 6 to 15.

The link table stores the association between the contract and the contractual components. Between the contract and the contractual components as many associations as desired and the function of the association can be stored, the associations being time-dependent. Release and amendment documents are also stored here. Various attributes are key fields for identifying links and time stamps, contract identification, the name of the contractual component, identification for the component table, etc.

By the “contractual component” is meant, in connection with this invention, the sum of the codings of a contractual component, i.e. the coding which represents the contractual component data and their process logic, e.g. in dialogue, or stores them in the contractual component table. The contractual component table in turn is or are the databank table or tables of the contractual component (which obviously does not occur in contractual components without their own databank table). By contractual component data are meant the data of a contractual component which are associated with a contract. The data are normally stored in one line of the contractual component table. However, there are also contractual components in which the data take up several lines, while other contractual components have no contractual component table at all but do have contractual component data.

In contrast to the prior art in which, when setting up a contract, the contents of its attributes are individually stored for each contractual component (i.e. in the present terminology a new set of data is added for each affected contractual component in the associated contractual component table), leading to a large quantity of superfluous and redundant data, according to the invention no new set of data is added to the contractual component table if a contractual component does not alter the data of the product which is the subject of the contract. This procedure is based on the realisation that in day to day mass business as a rule the product-specific attributes can be incorporated unchanged in the contract.

Advantageously, the databank table is buffered, which significantly improves access and speeds it up.

Each contractual component is in turn encapsulated in its own development category, leading to uncoupling.

According to the invention, the contractual components can be used in account management across different types of products, so that fields belonging to a common subject (relating to business management) can be grouped in one contractual component.

According to the invention, moreover, a distinction is drawn between generic contractual components and contractual components which are specific to the product type (account contractual components, card contractual components, joint card contractual components, joint account contractual components, etc). The generic contractual components contain features of a general nature such as for example, the attachment of the business partner, the contractual conditions, limits, payment connections, periods of notice, correspondence requirements, associated contracts, purpose of the contract, name of the contract etc, while the product type-specific contractual components contain attributes such as bank statements, closing of accounts, ledger updates, booking locks, debit instructions, confirmation of balance, basic account data, alternative names, etc.

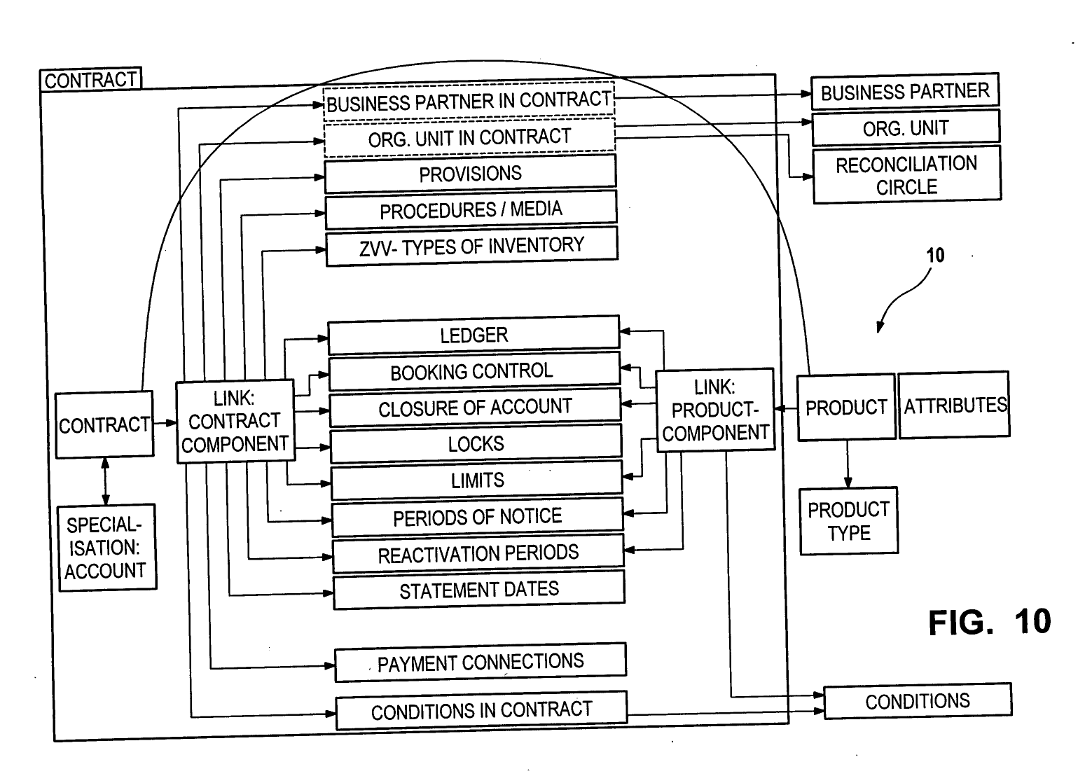

In the application architecture according to the invention there is an entity “Link: product component” or “product link” for short (cf. FIG. 10). This entity belongs to the bundle “contract” and not to the separate product configurator 10.

The task of the product link is to establish an association between a product (or a version of a product) and contractual components and in this way ensure that contractual components which do not alter the attributes of the product do not have to carry out an additional entries in the associated contractual component table.

In one particular link table, pointers to the contractual component data belonging to a product version are stored (i.e. a link between the product and an associated contractual component and its attributes). When a contract is set up these pointers are transferred to the contractual component so that they can be stored in the contractual component link table. The contract then points to the same contractual component data as the product. In this way there are product links between the product and the contractual components and contract links between the contract and the contractual components.

If there is a change in the product version certain features of the product are altered, which may affect one or more contractual components. Effects on the contractual components in turn affect one or more contracts. The corresponding contracts which are affected by the changes in the product are selected through data as to what the product is and the associated links are amended.

According to the invention it is thus possible to reuse the contractual components. Furthermore, the invention makes it possible to set up “contracts on contracts”, i.e. joint contracts such as joint card ownership etc can be run as one contract.

Contracts and contractual components are usage data (unlike products and product attributes which are so called customising data), which cannot be transported. The table of links between the product and the contractual component data is therefore a usage table as no contractual component data can be applied when setting up or configuring a product and thus no link can be generated between the product and the contractual component data.

According to the invention, when a contract is set up a contractual component does not all up the product directly but rather calls up the product link and the contractual component is provided with a link to contractual component data. When the contract is stored the contractual component checks whether the data taken from the product have been amended. If they have, the amended data are stored as a new entry in the contractual component table. If on the other hand the data have not been amended, only the link (product to contractual component data) is stored in the contractual link table (contract to contractual component table), with a note to the effect that the contract is not the “owner” of the contractual component data. The contractual component table remains unchanged.

The result of this process according to the invention is that there is an entry in the contractual component table showing both the product version and a very large number of contracts. In addition there are some other entries each of which has a contract point to it, namely when a contract has changed the attributes of the product. There is a note in the contract link table to say whether the contract is the “owner” of the contractual component data (i.e. whether the data belong individually to the contract) or not (i.e. the data belong to the product and the contract has simply “inherited” them through a link.

When a contract is first set up relating to a product or product version the product link table is still empty. If the product link notes that it has not yet stored any links to this product or to this product version, it asks the affected contractual components to bring up their “default values” from the associated product, store them and provide a link to the data stored. The links to the entries are noted by the product link in its own link table. It then indicates, when asked, the links to the individual contractual components as described.

When a contract is amended this is an individual amendment, i.e. contractual component data are amended with a new entry in the corresponding contractual component table and a new link in the contract link table.

When contracts are archived there is the particular feature that the contractual component data in which the contract is the “owner” are archived with the contract and with the links belonging to the contract. The contractual component data in which it is not the “owner” are not included in the archive as other contracts may be linked to these contractual component data.

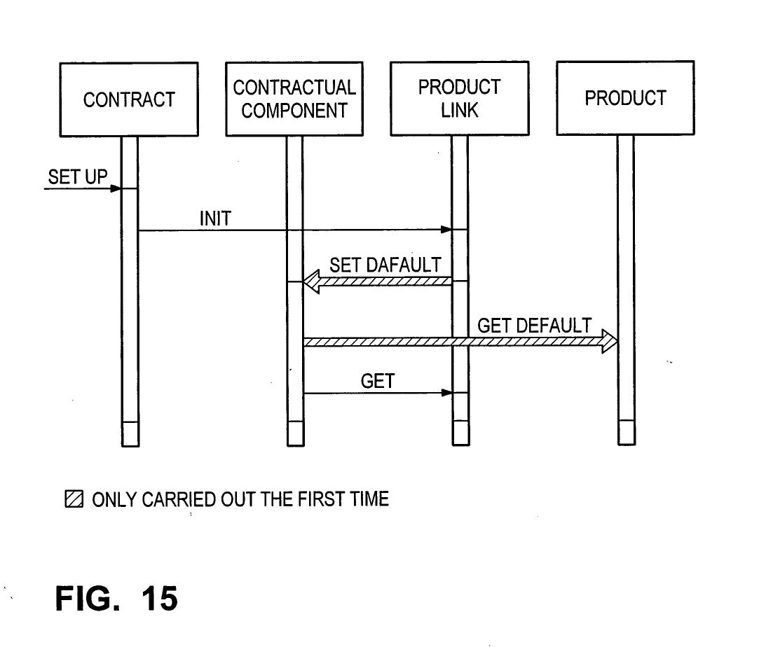

When a contract is set up (cf FIG. 15) the contract calls up the product link with “init”. If the product link establishes that it does not have any links to this product version, it calls up the relevant contractual components with “set default”. The contractual components then bring up their default values with “get default” from the product, store them and return the link to the product link. As the procedure continues the individual contractual components get their links with “get” from the product link. This means that the procedures “set default” and “get default” shown in bold in FIG. 15 are only carried out when a contract for a specific product or a specific product version is first set up.

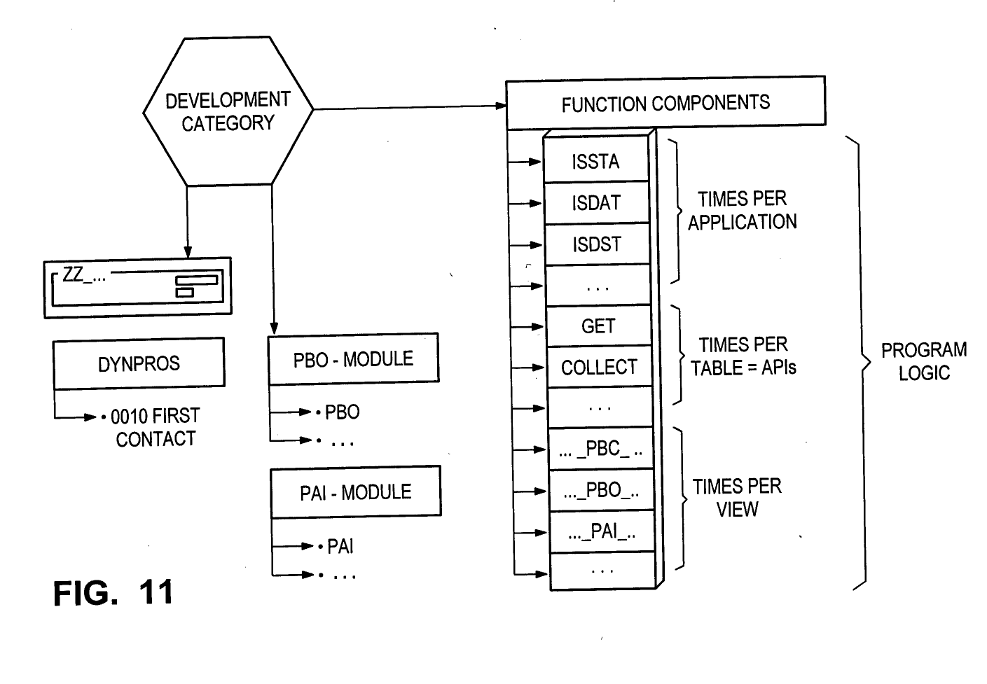

The abbreviations used in FIGS. 11 to 14 have the following meanings:
ISSTA Initialisation
ISDATRead data from the DB
ISDST Distribute data to participating application
FCODE Process own function code
XCHNG Check whether data have been amended
DCHCK Check before securing
DSAVB Collect data if application owns them
DTAKE Note data in overall memory
DSAVC Complete data (draw internal number)
DSAVE Store data in DB
DLVE1 Initialise actual memory
DLVE2 Initialise total memory

The invention is illustrated below by means of an embodiment by way of example for a fictitious product referred to as “easy” and a contractual component “ledger data”:

Setting Up the Product “Easy”

The product “easy” Version 1 is created in the customers customising system and tested. Finally it is transported into the productive system.

Setting up the First Contract

The first contract (No. 1) for the product “easy” is set up. The contract informs the product link that it should prepare itself for the product easy (call up init-API).

The product link establishes that there are no existing links to the product easy. It then calls up all the contractual components with set_defaults-API, including the ledger data. The ledge data then obtain their default values from the product easy, store them and generate a code for them (HB_{—}1). The code is returned to the product link. The product link stores all the links between the product easy and the contractual components.

Now the contractual components in succession call up the product link in order to get a link to their data. The contractual component “ledger data” thus calls up the product link with get_API and receives back the code HB_{—}1.

When the contract is stored (on the assumption that the ledger data have not been amended) the contractual component “ledger data” gives its code HB_{—}1 to the contractual link table and tells it that it is not the contract (but the product) that is the owner of the data.

The databank tables now have the following entries (simplified):

Contract Table

| Contract | Product | Product version |
|---|---|---|
| 1 | easy | 1 |

Contract link table

| Link_ID | Contract | Object type | Object ID | Owner |
|---|---|---|---|---|
| 1234567 | 1 | Ledger | HB_1 | No |

Contractual component ledger data

| Ledger Code | Attributes |
|---|---|
| HB_1 | . . . |

Product link

| Product | Product version | Object type | Object ID |
|---|---|---|---|
| Easy | 1 | Ledger | HB_1 |

Setting Up Standard Contracts

Now contracts 2 to 4 are set up. None of them changes the ledger data provided by the product (normal case).

The contract informs the product link that it should prepare itself for the product easy (calling up init-API).

The product link obtains the links for this product in its buffer.

Now the contractual components in succession call up the product link in order to obtain a link to their data. The contractual component “ledger data” thus calls up the product link with get_API and receives back the code HB_{—}1.

When the contract is stored the contractual component “ledger data” gives its code HB_{—}1 to the contract link table and tells it that it is not the contract but the product which is the owner of the data.

The data bank tables now have the following entries (simplified):

Contract Table

| Contract | Product | Product version |
|---|---|---|
| 1 | easy | 1 |
| 2 | easy | 1 |
| 3 | easy | 1 |
| 4 | easy | 1 |

Contract link table

| Link_ID | Contract | Object type | Object ID | Owner |
|---|---|---|---|---|
| 1234567 | 1 | Ledger | HB_1 | No |
| 2345678 | 2 | Ledger | HB_1 | No |
| 3456789 | 3 | Ledger | HB_1 | No |
| 4567890 | 4 | Ledger | HB_1 | No |

Contractual component ledger data

| Ledger Code | Attributes |
|---|---|
| HB_1 | . . . |

Product link

| Product | Product version | Object type | Object ID |
|---|---|---|---|
| Easy | 1 | Ledger | HB_1 |

Setting Up and Individual Contract

Contract 5 is set up. It individually amends the ledger data (exceptional case). The contract informs the product link that it is to prepare itself for the product easy (calls up init API).

The product link fetches the links to this product from its buffer. Now the contractual components in succession call up the product link to obtain a link to their data. The contractual component “ledger data” thus calls up the product link with get_API and receives back the code HB_{—}1.

The user then amends the ledger data shown and stores them.

The contractual component “ledger data” stores the amended data under a new code (HB_{—}2) and informs the contract link table of the new code and tells it that the contract is the individual owner of these data.

The databank tables now contain the following entries (simplified):

Contract Table

| Contract | Product | Product version |
|---|---|---|
| 1 | easy | 1 |
| 2 | easy | 1 |
| 3 | easy | 1 |
| 4 | easy | 1 |
| 5 | easy | 1 |

Contract link table

| Link_ID | Contract | Object type | Object ID | Owner |
|---|---|---|---|---|
| 1234567 | 1 | Ledger | HB_1 | No |
| 2345678 | 2 | Ledger | HB_1 | No |
| 3456789 | 3 | Ledger | HB_1 | No |
| 4567890 | 4 | Ledger | HB_1 | No |
| 5678901 | 5 | Ledger | HB_2 | Yes |

Contractual component ledger data

| Ledger Code | Attributes |
|---|---|
| HB_1 | . . . |
| HB_2 | ,,, |

Product link

| Product | Product version | Object type | Object ID |
|---|---|---|---|
| Easy | 1 | Ledger | HB_1 |

1. A computer-implemented method for generation and administration of contracts between a supplier and one or more customers, comprising:
storing for a contract core data relating to a product which is the subject of the contract and one or more contractual components; and
generating the contract electronically based on a selection of core data, the generating including depositing electronic references to the selected core data and contractual components.

2. The method according to claim 1, wherein a selection of the one or more contractual components is made and the admissibility of the choice of selected contractual components is automatically checked based on information and rules relating to the product which is the subject of the contract from the core data.

3. The method according to claim 1, wherein a central identification number is allocated to the generated contract, allowing a link to be made with external data.

4. The method according to claim 3, wherein the central identification number is unambiguous worldwide.

5. The method according to claim 1, wherein changes to the core data and/or to the contractual components spanning the contract are made in a central memory unit.

6. The method according to claim 1, wherein the contractual components are predefined.

7. The method according to claim 5, wherein amendments to the core data and/or to the contractual components are noted by time and deposited by means of links.

8. The method according to claim 1, wherein the supplier is a financial service provider and the product which is the subject of the contract is a financial products.

9. The method according to claim 1, wherein the contractual component checks, after generation of the contract, whether the core data associated with the product which is the subject of the contract has been changed, and, if not, initiates the storing of a link from the product to the contractual component in a contract link table which contains the link between the contract and the contractual component.

10. The method according to claim 1, wherein the contractual component checks, after generation of the contract, whether the core data associated with the product which is the subject of the contract has been changed, and, if so, arranges for the amendment to be stored as a new entry in a contractual component table.

11. An apparatus for generation and administration of contracts between a supplier and one or more customers, comprising:
means for storing for a contract core data relating to a product which is the subject of the contract and one or more contractual components; and
means for generating the contract electronically based on a selection of core data, the generating including depositing electronic references to the selected core data and contractual components.

12. The apparatus according to claim 11, wherein a selection of the one or more contractual components is made and the admissibility of the choice of selected contractual components is automatically checked based on information and rules relating to the product which is the subject of the contract from the core data.

13. The apparatus according to claim 11, wherein a central identification number is allocated to the generated contract, allowing a link to be made with external data.

14. The apparatus according to claim 13, wherein the central identification number is unambiguous worldwide.

15. The apparatus according to claim 11, wherein changes to the core data and/or to the contractual components spanning the contract are made in a central memory unit.

16. The apparatus according to claim 11, wherein the contractual components are predefined.

17. The apparatus according to claim 15, wherein amendments to the core data and/or to the contractual components are noted by time and deposited by means of links.

18. The apparatus according to claim 11, wherein the supplier is a financial service provider and the product which is the subject of the contract is a financial products.

19. The apparatus according to claim 11, wherein the contractual component checks, after generation of the contract, whether the core data associated with the product which is the subject of the contract has been changed, and, if not, initiates the storing of a link from the product to the contractual component in a contract link table which contains the link between the contract and the contractual component.

20. The apparatus according to claim 11, wherein the contractual component checks, after generation of the contract, whether the core data associated with the product which is the subject of the contract has been changed, and, if so, arranges for the amendment to be stored as a new entry in a contractual component table.
